(19) United States
(12) Patent Application Publication
(10) Pub. No.: US 2007/0030123 A1
(43) Pub. Date: Feb. 8, 2007

(54) Apparatus, system, and method for securely associating identification information with an electronic device

(76) Inventor: Robert S. Hoblit, Knightdale, NC (US)

Correspondence Address: KUNZLER & ASSOCIATES, 8 EAST BROADWAY, SUITE 600, SALT LAKE CITY, UT, 84111, US

(21) Appl. No.: 11/198,039

(22) Filed: Aug. 5, 2005

(51) Int. Cl. G05B 19/00

(52) U.S. Cl. 340/5.81; 235/382.5; 340/5.82; 340/5.85; 713/182

(57) ABSTRACT

An apparatus, system, and method are disclosed for securely associating identification information with an electronic device. The apparatus, system and method facilitate identifying an authorized user of an electronic device. An electronic display integrated the exterior of an electronic device (or a portion of the display) may be dedicated to displaying the identification information. The display may be viewable to onlookers and may be protected with a tamper evident element. The identification information may include electronic text, scanned images or a combination of such data. An authentication module may require a secure login with an authorized password and the appropriate rights to create or modify the identification information.

### BACKGROUND OF THE INVENTION

1. Field of the Invention

This invention relates to methods for preventing the theft of electronic devices and more particularly relates to apparatus, systems, and methods for securely associating identification information with an electronic device.

2. Description of the Related Art

Electronic devices have become ubiquitous in recent years. Some electronic devices make life more convenient, such as personal digital assistants, or provide mobile entertainment, such as media and game players. Other electronic devices, such as portable and laptop computers, allow work to be conducted and valuable information to be accessed anywhere.

Theft of portable electronic devices is relatively common. Surveys have indicated that over half of security and network professionals have reported losses due to laptop theft. Because it is common to see people operating a portable electronic device, the question of whether the user is the owner or an authorized user does not usually arise, even in the case of resale or purchasing of used equipment, which creates a market for stolen goods.

Replacing these devices may or may not cost a great deal of money, and in some cases, insurance covers the replacement cost. However, the real cost of laptop theft or the like is often in the information and data that is lost and the time and effort involved in configuring a replacement unit. Some of these devices, such as computing devices and personal digital assistants, are capable of carrying valuable, confidential information. The monetary value of this information to corporations and to individuals can be significant.

Corporations and individuals have tried a number of ways to prevent theft of electronic devices. Some solutions such as lock-down cables are cumbersome and difficult to manipulate. Other solutions have been to attach security plates, asset tags, tamper evident labels and the like to the outside of the electronic device in order to associate the electronic device with the owner or user. For example, some corporations use asset passes to check the electronic devices in and out of the company. Unfortunately, security plates and asset passes are often easily forged or removed.

FIG. 1 is a perspective view of an electronic device 110 with an attached prior art asset tag 120 for associating identification information with the electronic device 110, which in the depicted embodiment is a laptop. Typically, asset tags 120, security plates and the like provide a trackable serial number and/or barcode that may be associated with an owner and/or user's information and may be stored in a database. The asset tags 120 may display additional information, such as a company logo, address, contact phone number, an individual's name, or the like. In one embodiment, the electronic device 110 maybe checked in and out of company property by scanning a bar code and storing the associated. identification and user information in a company database. Generally, security personnel manually verify and track tagged electronic devices 110 belonging to the company.

One disadvantage of the prior art asset tags 120, however, is that the electronic device 110 is still susceptible to theft. Once stolen, it is not obvious that the electronic device 110 is being used by an unauthorized owner or user. In addition, the small asset tag 120 may be covered, tampered with, or removed, encouraging the use or resale of stolen equipment.

From the foregoing discussion, it should be apparent that a need exists for an apparatus, system, and method for securely associating identification information with an electronic device. Beneficially, such an apparatus, system, and method would enable quick identification of an authorized user, be tamper resistant, and discourage unauthorized use of an electronic device.

### SUMMARY OF THE INVENTION

The present invention has been developed in response to the present state of the art, and in particular, in response to the problems and needs in the art that have not yet been fully solved by currently available methods of associating identification information with an electronic device. Accordingly, the present invention has been developed to provide an apparatus, system, and method for securely associating identification information with an electronic device that overcome many or all of the above-discussed shortcomings in the art.

The apparatus for securely associating identification information with an electronic device is provided with a logic unit containing a plurality of modules configured to functionally execute the necessary steps of capturing identification information and displaying the identification information on a dedicated display integrated into the exterior of an electronic device. In one embodiment, the dedicated display is an assigned region of a general purpose display. These modules in the described embodiments include an authentication module to authenticate a user, an information capture module to capture identification information, and a display module to display identification information.

The apparatus, in one embodiment, is configured to display electronic identification information on the exterior of an electronic device such that the identification information may be easily viewed by onlookers. In certain embodiments, the identification information includes information relative to the electronic device as well as to the owner and/or authorized user(s) of the electronic device. In one embodiment, the identification information is displayed electronically and consists of an image, such as a scanned photograph or business card. In another embodiment, the identification information is displayed as text. In a further embodiment, combined images, such as scanned photographs and electronic text, may be displayed to identify authorized users. Identification information, in certain embodiments, may be displayed regardless of whether the electronic device is powered on.

A system of the present invention is also presented to securely associate identification information with an electronic device. In particular, the system, in one embodiment, includes an electronic device to be used by a specific user, a dedicated display permanently integrated into the exterior of the electronic device, an enclosure configured to protect the dedicated display, and a software module configured to create identification information for display. The system prevents tampering and enables an authorized user to create and/or modify identification information.

In certain embodiments, the system requires a user to securely log in with an authorized password and the appropriate rights to create and/or modify the electronic identification information. Consequently, unauthorized users are discouraged from using the electronic device and are denied access to the identification information. In one embodiment, multiple individuals may be authorized to use the device and the identification information of the last or current authorized user of the system is displayed.

A method of the present invention is also presented for securely associating identification information with an electronic device. The method in the disclosed embodiments substantially includes the steps necessary to carry out the functions presented above with respect to the operation of the described apparatus and system. In one embodiment, the method includes capturing identification information about an authorized user of an electronic device and displaying the identification information on a dedicated display integrated into the exterior of the electronic device. The method also may include securely modifying the identification information, authenticating a user through the use of a password, and allowing an authenticated user to modify the password.

The present invention offers distinct advantages over the prior art. Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The present invention enables onlookers and security personnel to easily identify an authorized user of an electronic device. The apparatus, system and method for securely associating identification information with an electronic device may provide a tamper-proof and permanently dedicated display in the exterior of an electronic device, making the display of identification information virtually impossible to remove or hide without notice. In addition, the apparatus, system and method preclude duplication and imitation, thus preventing fraud and deterring theft. These and other features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view of one embodiment of a laptop with an attached prior art asset tag for associating identification information with an electronic device;

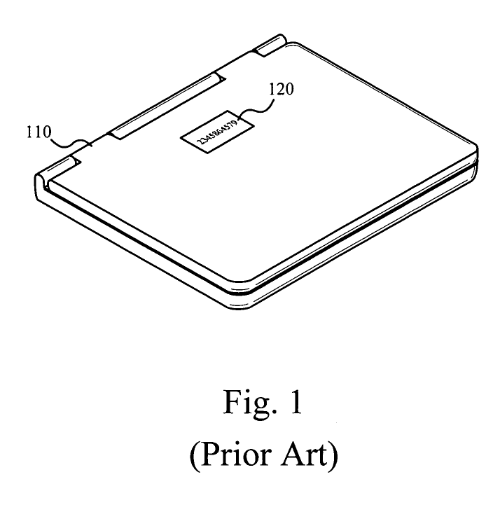

FIG. 2A is a perspective view of one embodiment of a laptop with an embedded identification association system in accordance with the present invention;

FIGS. 2B-2C are perspective views of one embodiment of a dedicated display of identification information in accordance with the present invention;

FIG. 3 is a block diagram depicting one embodiment of an identification management system in accordance with the present invention; and

FIG. 4 is a flow chart diagram depicting one embodiment of an identification management method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

In the following description, numerous specific details are provided, such as examples of programming, software modules, user selections, network transactions, database queries, database structures, hardware modules, hardware circuits, hardware chips, etc., to provide a thorough understanding of embodiments of the invention. The described features, structures, or characteristics of the invention may be combined in any suitable manner in one or more embodiments. Furthermore, one skilled in the relevant art will recognize that the invention can be practiced without one or more of the specific details, or with other methods, components, materials, and so forth. In other instances, well-known structures, materials, or operations are not shown or described in detail to avoid obscuring aspects of the invention.

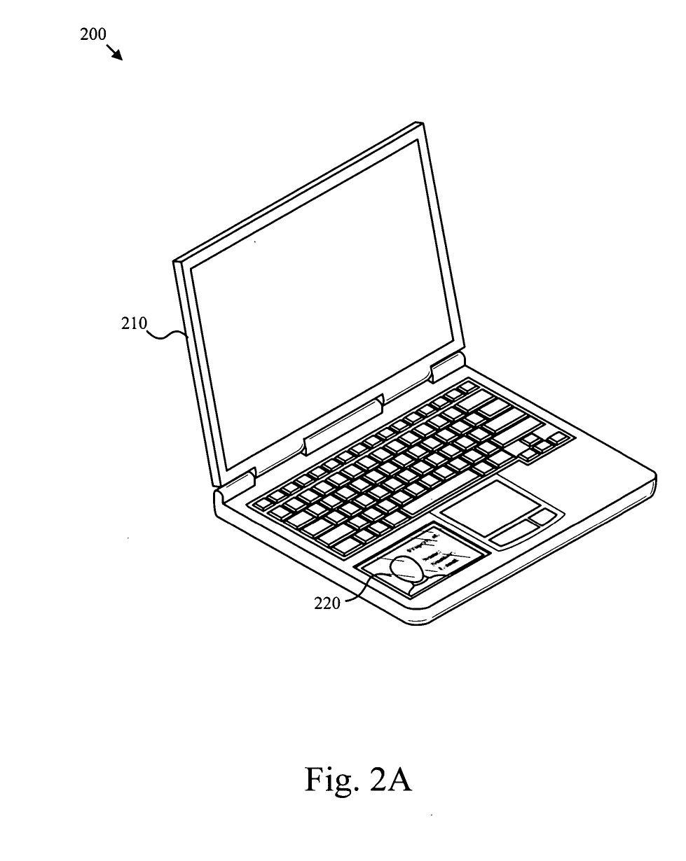

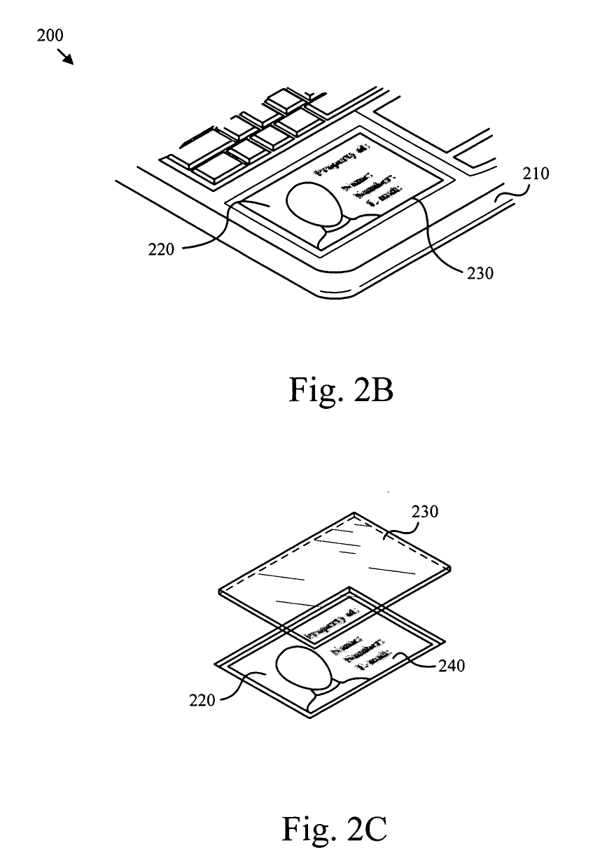

FIGS. 2A-2C illustrate one embodiment of an identification association system 200 of the present invention. As depicted, the identification association system 200 includes an electronic device 210, an embedded dedicated display 220, an enclosure 230 and identification information 240, which may be provided by a software module (not shown) or the like. The identification association system 200 facilitates securely associating identification information with an electronic device 210. The prominent and obvious nature of the identification information 240 helps ensure that the electronic device 210 is not stolen or used by unauthorized individuals.

The electronic device 210 may be any electronic device 210 that could benefit from identification association to help maintain security and prevent loss. Many electronic devices 210 can be stolen or lost relatively easily and may benefit from affixed identification. Particularly, companies who frequently authorize limited use of electronic devices 210 may be able to more easily track and secure electronic devices 210.

In one embodiment of the present invention, the electronic device 210 is a computing device, such as the depicted laptop or the like. In another embodiment, the electronic device 210 is an electronic organizer, such as a PDA (Personal Digital Assistant) or the like. Alternatively, other electronic devices 210, such as cameras, media equipment, and the like may beneficially include a dedicated display 220 or display region 220 that is dedicated to displaying identification information 240. Those of skill in the art will recognize that the present invention may be applied to various applications and is, therefore, not limited to the illustrated embodiments.

The depicted identification association system 200 uses a dedicated display 220 prominently positioned next to the keyboard. In one embodiment, the dedicated display 220 is a specific portion of a general purpose display. The dedicated display or display region 220 may be dedicated to displaying identification information 240 continually and may be permanently embedded into the case of the electronic device 210. Embedding the dedicated display 220 prevents removal and/or unauthorized alteration of the identification information.

The exterior of the electronic device 210 may be configured to display identification information 240 such that the display 220 is easily viewable to the user. Furthermore, the display 220 may display the electronic information in a manner such that onlookers may easily view the identification information 240.

The display 220 may be protected by a durable enclosure 230, such as the depicted transparent cover 230. The enclosure 230 may serve multiple purposes, including, but not limited to, enabling secure visual display of identification information, visual protection from tampering, and physical protection of the display 220. For example, the transparent cover 230 may protect the dedicated display 220 from normal wear and tear as well as from accidental damage. In one embodiment, the transparent cover 230 is permanently attached to the cover of the electronic device 220 so that the cover 230 cannot be removed without causing damage. In certain embodiments, the transparent cover 230 is made of a material that easily shows evidence of any tampering as is known in the art.

The identification information 240 may identify a currently authorized user and/or the owner of the electronic device 210. In one embodiment, the identification information 240 includes electronic text. In another embodiment, the identification information 240 is created from an image, such as a scanned business card, photo ID, or the like. Alternatively, the identification information 240 may comprise a combination of text and one or more images. In certain embodiments, the dedicated display 220 displays the identification information 240 regardless of the power state of the electronic device. In other words, the dedicated display 220 may display the identification information 240 regardless of whether the electronic device 210 is on or off.

In select embodiments, the identification information 240 and/or the visual display 220 can only be changed using software that requires an authorized user's login. The software may enable authorized modification of the identification information 240. In one embodiment, each authorized user has unique identification information 240 and the dedicated display 220 displays the identification information 240 of the current or last authorized user.

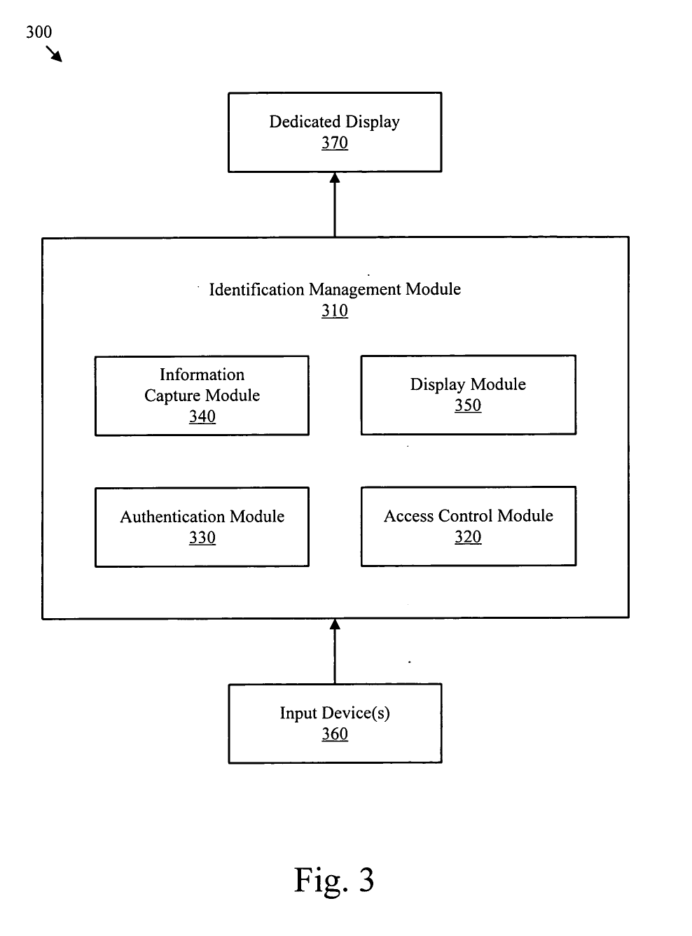

FIG. 3 is a block diagram depicting one embodiment of an identification management system 300 of the present invention. As depicted, the identification management system 300 includes an identification association module 310, an input device 360, and a dedicated display 370. The identification management system 300 is a functional representation of one example of the identification association system 200 depicted in FIG. 2.

The depicted identification management module 310 enables the creation, modification, and electronic display of identification information of an authorized user of an electronic device. In the depicted embodiment, the identification management module 310 includes an access control module 320, an authentication module 330, an information capture module 340, and a display module 350. Beneficially, the identification management module 310 may be tamper proof and may clearly identify the authorized user of an electronic device 210 (FIG. 2), thereby reducing the likelihood of the electronic device 210 being stolen or used by an unauthorized user.

As illustrated in FIG. 3, the access control module 320 may control access to the modules of the identification management module 310 and prevent access by unauthorized software. In certain embodiments, the access control module 320 requires a software module to receive a random seed value and generate a valid security code from the random seed value before access is granted to the authentication module 330, the information capture module 340, or the display module 350. In one embodiment, the access control module 320 also verifies that the module requesting access resides within firmware of the electronic device as a condition of access.

The authentication module 330 ensures that only authorized persons can create and/or change the identification information. The authentication module 330 may require a secure login with an authorized password or the like to verify authorized use. In one embodiment, biometric information provided by an input device 360 is verified before the user is authenticated. In some embodiments, the authentication module 330 is used in conjunction with a standard login dialog associated with the operating system.

In certain embodiments, once a user is authenticated, the user may modify a password or password sequence to ensure continued security. In addition, the authentication module 330 may check the user's rights to ensure that the user has the appropriate rights to either create or modify the identification information 240 and/or password.

The identification information capture module 340 captures information that identifies an authorized user of an electronic device 210 in order to create identification information 240 appropriate for display. The information capture module 340 may accept several types of information input by various means and may convert the input to electronic information suitable to be displayed on an electronic display embedded into the exterior of an electronic device. In one embodiment, the identification information 240 is derived from an cn image, such as a scanned image, photo or the like. In another embodiment, a user inputs the identification information from an input device such as a keyboard.

The identification information may identify the electronic device 210 as well as the authorized user. In one embodiment, the identification information consists of biometric information identifying the authorized user. In certain embodiments, the information is converted into information suitable only for reading or display. Epapers, such as those created by postscript converters, are current examples of information created for purposes of reading or display. The identification information capture module 340 may also include the capability to modify the identification information 240. Consequently, a user authorized to change the displayed information may make the necessary changes when the identification information changes.

The display module 350 controls the dedicated display 370. In one embodiment, the identification capture module 320 passes the identification information to the display module 350. The display module 350 subsequently refreshes the identification information into the dedicated display 370. In one embodiment, the display module is hardwired to the dedicated display 370 thus preventing access to the dedicated display or display region by other modules.

The following schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. For example, the order in which a particular method occurs may or may not strictly adhere to the order of the corresponding steps shown.

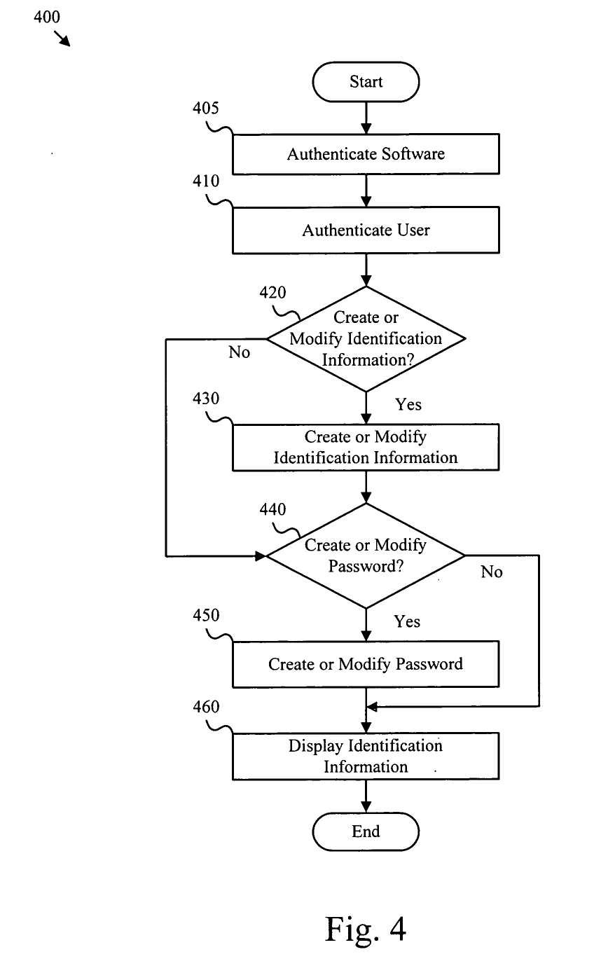

FIG. 4 is a flow chart diagram depicting one embodiment of an identification management method 400 of the present invention. As depicted, the identification management method 400 includes an authenticate software operation 405, an authenticate user operation 410, a create or modify test 420, a create or modify identification information 430 operation, a create or modify password test 440, a create or modify password test 450, and a display identification information operation 460. Beneficially, the identification management method 400 allows authorized users to easily create, modify and display information identifying an authorized user of an electronic device, helping to secure the device from theft or use by unauthorized individuals.

In certain embodiments, the authentication module 330 may conduct one or more authentication operations 405 software to ensure that the software has the appropriate security code(s) and/or rights to access the modules of the identification information module 310. The authenticate software operation 405 may require generating a valid security code from a random key before granting access to the authentication module 330, the information capture module 340, or the display module 350. In some embodiments, the authenticate software operation 405 verifies that the software requesting authentication resides within the firmware of the electronic device.

In additional embodiments, the authentication module 330 may authenticate 410 a new user to ensure that the user has the appropriate password(s) and/or rights to create or modify the identification information. The authentication module 330 may prompt the user for a password and then check whether the password is authentic and whether the user has the appropriate rights. If the user's password is correct and if the user has the appropriate rights, the identification management method 400 continues to the create or modify test 420.

If the authenticated user desires to create or modify the identification information and has proper permissions, the identification management method 400 may grant the user access to create or modify 430 the identification information. In one embodiment, if the user wants to enter new information, the identification information capture module 340 checks whether the information is to be created from an image or whether the identification information is to be input or brought in from another software such as a word processor. If the data is to be input, the identification information capture module 340 may prompt the user for the appropriate information, such as the authorized user's name, contact information and the like. After the data input is complete, the date may be converted into a displayable format. Alternatively, the user may proceed to the create or modify test 440 in order to create 450 a password for a new user or modify 450 a password for an existing user.

After the display information has been created or modified, the identification management method 400 may proceed to display 460 the identification information. In certain embodiments, the display module 350 receives the identification information from the information capture module 340 and provides the identification information to the dedicated display 370.

In some embodiments, the display module 350 exists on an external computing device, such as a server, and uses a network connection to download the information to the dedicated display 370. In another embodiment, the information capture module 340 exists onboard the electronic device 210 and downloads the identification information to the dedicated display 370 onboard the electronic device 210. In an additional embodiment, the display module 350 copies the identification information onto removable media, which is then placed into the electronic device 210. The identification information is then loaded into the dedicated display 370. In another embodiment, the display module 350 is integrated into the electronic device 210 and controls the dedicated display. In such an embodiment, the display module 350 could cause the display to operate regardless of whether the electronic device 210 is powered on or off.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for securely associating identification information with an electronic device, the method comprising:
capturing identification information about an authorized user of an electronic device; and
displaying the identification information on a display integrated into the exterior of the electronic device wherein at least a portion of the display is dedicated to displaying the identification information.

2. The method of claim 1, wherein displaying the identification information comprises displaying text information.

3. The method of claim 1, wherein displaying the identification information comprises displaying an image.

4. The method of claim 1, wherein the electronic device is a computing device.

5. The method of claim 1, further comprising securely modifying the identification information.

6. The method of claim 1, further comprising authenticating a user through a login process.

7. The method of claim 6, further comprising collecting biometric information.

8. The method of claim 1, further comprising allowing an authenticated user to modify the password.

9. An apparatus for securely associating identification information with an electronic device, the apparatus comprising:
an authentication module configured to authenticate a user;
an information capture module configured to capture identification information; and
a display integrated into the exterior of an electronic device wherein at least a portion of the display is dedicated to displaying the identification information.

10. The apparatus of claim 9, wherein the information capture module is further configured to capture information sufficient to identify the electronic device.

11. The apparatus of claim 9, wherein the information capture module is further configured to capture information sufficient to identify an authorized user.

12. The apparatus of claim 9, further comprising an access control module configured to limit software access to the identification information.

13. The apparatus of claim 9, wherein the information capture module is further configured to allow only an authenticated user to change the identification information.

14. The apparatus of claim 9, wherein the authentication module is further configured to conduct a login process.

15. The apparatus of claim 9, wherein the authentication module is further configured to confirm the users rights to access the identification information.

16. The apparatus of claim 9, wherein the dedicated display is further configured to display the identification information in an inactive state.

17. The apparatus of claim 9, wherein the dedicated display is further configured with a tamper evident element.

18. An apparatus for securely associating identification information with an electronic device, the apparatus comprising:
means for authenticating a user;
means for capturing identification information; and
means for displaying the identification information on a display integrated into the exterior of an electronic device wherein at least a portion of the display is dedicated to displaying the identification information.

19. A system for securely associating identification information with an electronic device, the system comprising:
an electronic device configured to be used by an authorized user;
a display integrated into the exterior of the electronic device, at least a portion of the display dedicated to displaying identification information;

20. A signal bearing medium tangibly embodying a program of machine readable instructions executable by a digital processing apparatus to perform operations to securely associate identification information with an electronic device, the operations comprising:
operations for capturing identification information from an authorized user; and
operations for displaying the identification information on a display integrated into the exterior of an electronic device wherein at least a portion of the display is dedicated to displaying the identification information.

21. The signal bearing medium of claim 20, further comprising operations for securely modifying the identification information.
